(19) United States
(12) Patent Application Publication
(10) Pub. No.: US 2014/0052573 A1
(43) Pub. Date: Feb. 20, 2014

(54) SYSTEM FOR PURCHASING AND MANAGING AN ITEM USING A TERMINAL AND A REFRIGERATOR USING THE SAME

(71) Applicants: Minjin Oh, Changwon-si (KR); Yongjoon Kim, Changwon-si (KR); Hyoungjun Park, Changwon-si (KR); Jonghoon Shim, Changwon-si (KR)

(72) Inventors: Minjin Oh, Changwon-si (KR); Yongjoon Kim, Changwon-si (KR); Hyoungjun Park, Changwon-si (KR); Jonghoon Shim, Changwon-si (KR)

(73) Assignee: LG ELECTRONICS INC, Seoul (KR)

(21) Appl. No.: 14/113,661

(22) PCT Filed: Aug. 10, 2012
(86) PCT No.: PCT/KR12/06376

§ 371 Date: Oct. 24, 2013

(30) Foreign Application Priority Data
Aug. 12, 2011 (KR) 10-2011-0080520

(51) Int. Cl. G06Q 30/06

(52) U.S. Cl. CPC G06Q 30/0633
USPC 705/26.8

(57) ABSTRACT

The present invention relates to an information management system, and more specifically, to an information management system capable of managing information about products stored in a storeroom of home appliances or a shopping list, or purchasing products from an external market through a terminal connected to and communicated with the home appliances and managing information about the purchased products.

### TECHNICAL FIELD

The present invention relates to an information management system, and more specifically, to an information management system capable of managing information about products stored in a storeroom of home appliances or a shopping list, or purchasing products from an external market through a terminal connected to and communicated with the home appliances and managing information about the purchased products.

### BACKGROUND ART

A refrigerator, one kind of home appliances, can keep food or other goods refrigerated or frozen.

A main purpose of home appliances such as the refrigerator is to increase the duration of stored goods without damaging the states of the stored goods.

However, a need for smart home appliances capable of providing various types of information to users in addition to original functions thereof has recently increased.

As home appliances become smart, refrigerators also need to visually provide information about the refrigerators and necessary information for users to the user so as to improve user information access.

Furthermore, there is a need to realize a bi-directional information transmission system in the refrigerator, by which a user processes specific information and inputs the processed information to the refrigerator such that the input information is used for an operation of the refrigerator or other purposes.

### DISCLOSURE OF INVENTION

### Technical Problem

An object of the present invention is to provide an information management system capable of managing a shopping list generated through a terminal interconnected with home appliances, purchasing an item from an external market through the terminal, and managing information about the purchased item.

### Solution to Problem

According to one aspect of the present invention, an information management system comprises terminal including a memory for storing storage information about items stored in a storage of home appliances capable of storing predetermined items and information about a shopping list, an input/output unit for inputting/outputting the storage information and the information about the shopping list, a communication unit connected to a management server of an external market through a predetermined communication network to enable shopping based on the shopping list, and a controller for controlling the input/output unit, the memory and the communication unit, and a server configured to be connected to the terminal through the communication network, to store and manage shopping information and the shopping list information input through the terminal, and to change contents of the stored information according to a shopping result at the market.

The server may include a database server related to shopping information, and databases constructing the database server may comprise a user information database in which personal information for identifying a user is stored, a shopping list information database in which the shopping list information is stored, a purchase history information database in which shopping history information of the user is stored, and a product information database in which information about details of items on the shopping list or the shopping history is stored.

The server may include a device management server for managing information about operations of home appliances communicating with the terminal.

The input/output unit may be configured of a display unit implemented as a touch screen. The display unit may display a virtual storage of home appliances and information about stored items or an icon corresponding to an item related to the shopping information. The icon may be located outside or inside of the virtual storage according to drag and drop operations.

The controller may display the shopping list input by the user on the display unit when the user presses a shopping list button.

When the user selects a specific item included in the shopping list and inputs a command for viewing information about the specific item, the controller may receive information about the specific item, provided by external market management servers, and display the received information on the display unit.

The information about the specific item may include price information provided by a plurality of external markets.

Markets connected to management servers providing the information about the specific item may be located within a predetermined distance from the location of the home appliances or designated by the user.

When the user selects a specific item of a specific market, inputs an order command and then inputs a payment command, the controller may display a payment information input window provided by a predetermined payment service provider on the display unit.

When the user inputs an order or delivery check command, the controller may receive delivery related information from a management server of the specific market and display order information or delivery information on the display unit.

When a list of delivered items is received from the management server of the specific market, the controller may display a list of purchased items and a virtual storage on the display unit. The list of purchased items may include icons representing the items and the items may be located in the virtual storage according to drag and drop operations.

According to another aspect of the present invention, A refrigerator comprises a storeroom capable of storing predetermined items and a terminal provided to a door for opening and closing the storeroom, the terminal to store, input and output storage information about food or items stored in the storeroom and a shopping list, and to be connected to a management server of an external market through a communication network to input/output predetermined shopping related information to enable shopping of food or stored items. The terminal displays information about the shopping list, information about items included in the shopping list, received from the management server of the external market, information about purchased items according to a shopping result at the market and storage information related to the information about purchased items.

### Advantageous Effects of Invention

According to the present invention, it is possible to conveniently purchase a necessary product using a personal communication terminal or a terminal provided to home appliances.

Particularly, when home appliances for storing goods or products, such as a refrigerator, are used, a user can easily recognize excess/insufficiency of a stored item or a to-be-stored item and generate a list of necessary items using a predetermined terminal.

Information about items included in a shopping list can be received from a management server of a market in real time and provided to a user to thereby improve user convenience.

Furthermore, since prices of items and other information can be clearly displayed for each market, a wide choice of items can be provided to the user.

Moreover, after delivery of items, a list of delivered items can be downloaded and the items included in the list can be easily managed through a food management menu.

That is, the items in the list can be displayed using predetermined icons and the icons can be moved to a virtual storage displayed on a display so as to match the items with actual storage states.

Accordingly, the user can easily check the storage states of the stored items without opening an actual storage.

### BRIEF DESCRIPTION OF DRAWINGS

FIG. 1 illustrates an information management system according to the present invention;

FIG. 2 is a flowchart illustrating information flow in the information management system according to the present invention;

FIG. 3 is a block diagram of a terminal for home appliances, to which the present invention is applied;

FIG. 4 shows an initial screen of a display unit according to the present invention;

FIG. 5 illustrates a shopping list displayed on the display unit according to the present invention;

FIG. 6 illustrates an item information screen displayed on the display unit according to the present invention;

FIG. 7 illustrates an order list displayed on the display unit according to the present invention;

FIG. 8 illustrates a payment screen displayed on the display unit according to the present invention;

FIG. 9 illustrates a payment completion screen displayed on the display unit according to the present invention;

FIG. 10 illustrates an order check screen displayed on the display unit according to the present invention;

FIG. 11 illustrates an item management screen displayed on the display unit according to the present invention;

FIG. 12 illustrates a food management menu displayed on the display unit according to the present invention; and

FIGS. 13 and 14 are flowcharts illustrating shopping and purchased item management based on a shopping list according to the present invention.

### BEST MODE FOR CARRYING OUT THE INVENTION

Embodiments of the present invention will be described with reference to the attached drawings.

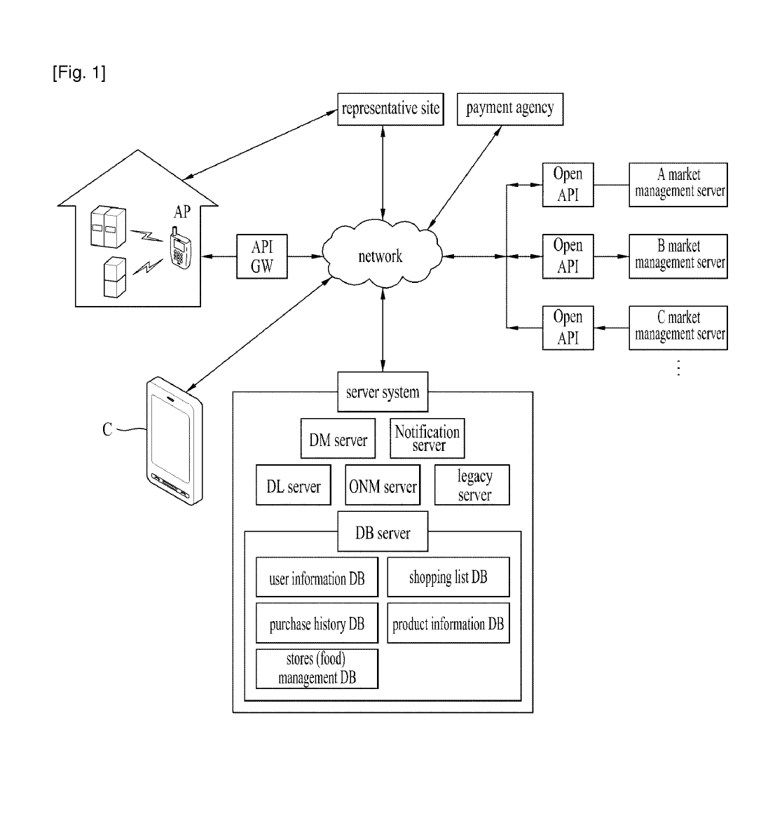

As shown in FIG. 1, an information management system according to an embodiment of the present invention is implemented in such a manner that home appliances and terminals provided to the home appliances are linked with an external server, a representative Internet site of a home application manufacturer, and management servers of markets that sell products online and off-line.

The information management system may manage operations of the home appliances or check whether states of the home appliances are abnormal using communication between the terminals provided to the home appliances and the external server.

Information about an item stored in home appliances capable of storing predetermined goods, such as a refrigerator, may be managed in such a manner that the information is input, output, stored or changed.

Furthermore, it is possible to manage a shopping list input through a terminal and to provide information (e.g. price information, sale event, etc.) about items included in the shopping list and information about shopping malls such as markets providing an appropriate purchase service to users.

To provide this service, terminals provided to home appliances in a home may be connected through wired Internet or connected through a wireless Internet sharing router such that they can communicate.

For communication through a terminal provided to the home appliances, a terminal or home appliance account is needed.

It is possible to recognize a terminal of home appliances that performs communication through an account thereof and to be provided with various management services through the account.

To achieve this, a user can acquire an account of each terminal by inputting a serial number of the terminal or a device ID of home appliances corresponding to the terminal when joining the representative Internet site of the home appliance manufacturer.

Information about the terminal having the acquired account is provided to a server system which will be described below through a network, and remote diagnosis, operation information management, firmware update, shopping list management, post-purchase management, and stored item or stored food management for the home appliances corresponding to the terminal can be performed on the basis of the information.

A terminal included in home appliances or the home appliances may include a communication module for communicating with the server system and a client protocol for executing an instruction transmitted from the server system.

For home appliances that cannot be managed by the server system, an additional apparatus including the above-mentioned communication module and client protocol may be used.

The user can be provided with a service from the server system by purchasing the additional apparatus and connecting the additional apparatus to the home appliances.

When home appliances or a terminal connected to the home appliances access the service system, the server system may specify the home appliances through the account of the terminal or the home appliances.

Property information (e.g. product type, model information, etc.) of the home appliances may be registered with the account in the server system.

Here, the account may be generated irrespective of the property information of the home appliances, such as product type or model information, and the property information may be coded with the account.

Accordingly, the server system may recognize the type or model information of the home appliances using only the account.

The user may request a service through home appliances to be provided with the service if the home appliances are registered in the server system.

For example, when the user selects a desired service through a display window of a refrigerator and inputs the service, the refrigerator can communicate with the server system to request the service.

To allow the user to conveniently request a service and extend the range of home appliance management service items, it may be necessary to enable service request through means other than home appliances.

When the user accesses the server system through home appliances, the server system can specify a service target since the server system is accessed through the account of the home appliances or a terminal connected to the home appliances. However, when the server system is accessed without using home appliances, it may be necessary to determine how the server system specifies home appliances corresponding to a service target.

For example, the user can request a service by accessing a representative site and inputting the account of home appliances to be served.

In this case, however, the user needs to memorize all accounts of home appliances owned by the user.

The aforementioned representative site may be generated to mitigate this inconvenience. The user can join the representative site to be given an ID and a password.

The user can register all the home appliances belonging to the user by logging in the representative site.

Home appliances registered in the representative site may be registered along with user ID in the server system.

Registration may also be performed in such a manner that the representative site transmits information about the home appliances to the server system.

Furthermore, registration of home appliances in the server system may be carried out through an activation procedure which will be described below.

In any case, when the user is issued a user ID, the user ID can be registered with home appliances belonging to the user in the server system and managed.

A service requested by the user through the representative site may be provided when an operator issues a command for the corresponding management service for the server system. Otherwise, the representative site may be connected to the server system through an open API. In this case, the user can directly request management to the server system.

The server system includes a server protocol for management services, and the server protocol provides a requested management service in connection with the client management protocol of the corresponding home appliances.

An OMA DM protocol may be used as a protocol for performing the above management service between the server system and home appliances. Solutions other than the OMA DM may also be used. While the OMA DM is used in the present embodiment, the present invention is not limited thereto.

The following management procedures may be used to provide the above management service.

Bootstrap: When a device management (DM) client of a terminal initially performs a management session, authentication information with respect to a DM server and network configuration information for network connection are needed. A procedure for this is referred to as bootstrapping.

Provisioning: A terminal that initially performs a management session is registered in the DM server through bootstrap, and a terminal configuration is updated in order to provide a service to the terminal. A procedure for this is referred to as provisioning.

Configuration management: A management operation of checking or changing terminal related configuration information, or configuring, checking or changing service related information is referred to as device configuration management.

Control management: This is a management operation of controlling a terminal.

User alert: The DM server can signal the contents of a management operation to a user through a terminal screen or receive acknowledgement by sending an alert signal to a DM client. That is, improved management can be achieved through interaction between the DM server and the user.

Diagnostic and monitoring: Performance deterioration or fault may be generated while a user uses a terminal. Accordingly, it is necessary to recognize this state in advance and take a measure suitable to the recognized state to provide the user a stabilized environment in which corresponding home appliances can be used. This work is referred to as diagnostic and monitoring management.

Firmware update management: A terminal manufacturer may update firmware if a terminal has a trouble or a function of the terminal is changed after the manufacturer sells the terminal, a management operation for this is firmware update management.

Software component management: A management operation of installing a software component in a terminal, updating the software component or deleting the software component is referred to as software management.

Backup and restore management: This backs up/restores data of a terminal in the DM server.

Server systems may be installed in a plurality of places in a distributed manner. For example, server system 1 is installed in Korea and server system 2 is installed in the U.S.

The server system may be divided into a plurality of servers according to function.

The server system may include the following servers. However, the present invention is not limited thereto.

<DM Server>

The DM server sends a terminal management command to a DM client of a terminal.

That is, the DM server provides a management function of remotely processing firmware update (modem firmware/OS) management, software management, diagnostic management, etc. through the terminal management command.

The DM server may include a session management region, a security management region, a DM protocol process region, a SyncML protocol engine region, etc.

<DL Server>

The DL server transmits a file to the DL client. That is, the DL server delivers information of a to-be-transmitted file through a download descriptor (DD) such that the DL client correctly downloads the file. The downloaded file includes a firmware update package and a software management package. The DL server may include a session management region, a package management region and a download region.

<ONM Server or User Portal>

The ONM server is interfaced with the DM server or DL server and a legacy server and implements a business logic. An operator may issue a management command or check management information through a management web page of the ONM server.

The user portal provides some functions of ONM to general users. This is implemented through an open API of the DM server. A user may request a management service to the DM server through the user portal.

<Legacy Server>

Representative legacy servers operating in connection with the ONM server include a server receiving terminal information and a server receiving user information. That is, the legacy server provides information for implementing the business logic by delivering the user information or terminal information to the ONM server.

<Notification Server>

The notification server transmits a notification message of the DM server to a terminal. The notification server may include a session generation region, a schedule management region, etc.

If the terminal is present in a private network, a connection manager specially provided to a server for maintaining a link with the terminal may be needed. The terminal may automatically request TCP connection after booting up and the connection manager maintains the requested TCP connection. The DM server transmits the notification message through the TCP connection.

The notification server can communicate with a mobile terminal of a user, home appliances, or a terminal of the home appliances and, if information about the home appliances (stored item management information, a shopping list, item purchase completion information, and payment information) is changed, signals information change to the user.

<Open API>

Applications of a mobile communication terminal such as a smartphone can remotely manage terminals through an open API provided by the DM server.

The server system may include a database server.

The database server may include a user information database storing personal information of users who obtain IDs by joining the representative site.

The user information database may store personal information (name, address, phone number, etc.) of a user. The user information database may also store information (the number of home appliances, type, etc.) about home appliances owned by the user.

The database server may include a shopping list database generated by a user using a mobile terminal, a terminal provided to home appliances, or the home appliances.

Particularly, in the case of a refrigerator having a stored item management function, a user can generate a list of food and other goods that need to be purchased using a terminal provided to the refrigerator while managing stored goods such as food.

Accordingly, the shopping list database stores the shopping list generated through this procedure and can support matching of items included in the shopping list with information provided by a management server connected to a specific market.

The database server may include a purchase history database capable of storing and managing details of goods that were purchased by the user, i.e., shopping history information.

Furthermore, the database server may include a product information database storing information about details (price information, information about markets which carry products, information about event items, etc.) of items included in the purchase history database or the shopping list database.

In addition, the database server may include a stored item management database capable of storing and managing information about storage states of food or other items stored in a refrigerator, for example.

The aforementioned servers may execute their functions by directly accessing targets.

Meantime, the terminal of the home appliances and the server system are linked with a management server of each market through a communication network.

Particularly, the management server of each market and the terminal of the home appliances may be linked to each other via an open API and an API gate to exchange optimized information necessary to purchase products.

The market associated with the management server linked with the terminal of the home appliances may be a market located within a local range designated by the user or within a predetermined distance from the home appliances.

Otherwise, the market may be a specialized market.

When the user purchases an item from the market using the terminal of the home appliances and charges the item, a payment agency that performs payment by proxy and receives a commission is needed. This proxy payment may be performed by a bank or a credit card company.

To achieve this, a payment program provided by the payment agent may be installed in the terminal of the home appliances and a payment interface necessary for payment may be displayed on a display of the terminal.

A mobile terminal C, such as a smartphone, a notebook PC or a tablet PC, may be linked to the communication network. It is possible to manage a shopping list or to check details of shopping, delivery information, etc. through the mobile terminal C.

Particularly, when a dedicated application is installed in a mobile terminal, information check and management can be performed more conveniently.

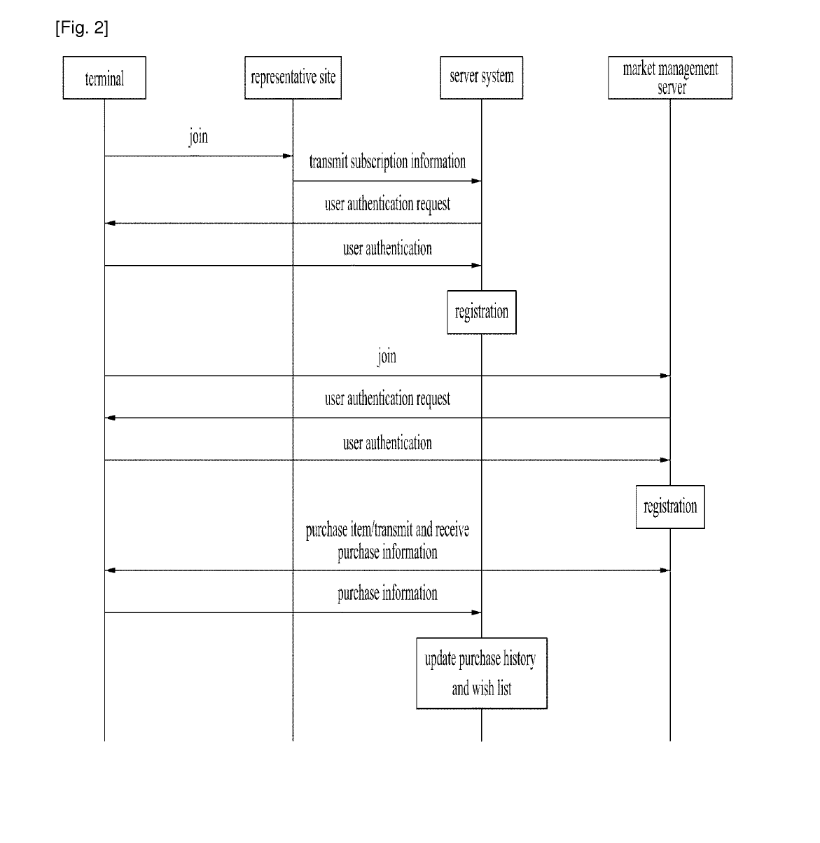

FIG. 2 is an information flowchart of the information management system according to the present invention.

A user accesses and joins a representative site operated by a manufacturer of home appliances belonging to the user using a terminal provided to the home appliances or a personal wireless mobile terminal.

The user may join the representative site by inputting a user ID, a password, and an ID or identification code of the home appliances owned by the user.

The representative site transmits the information input by the user to the server system. The server system sends a user authentication request to the terminal of the user on the basis of the information transmitted from the representative site.

The user can perform authentication by inputting an authentication code or an authentication number at the authentication request from the server system.

Upon connection between the user and the server system, information generated or managed by the user through the terminal can be transmitted to the server system and managed by the server system.

If the user wants to purchase an item online at a specific market, the user joins a site operated by a management server corresponding to the market.

Here, the market management server requests user authentication. The user can perform authentication using an authentication code or an authentication number.

When the terminal of the user is linked with the market management server, the user can purchase an item and thus purchase information may be transmitted/received between the market management server and the terminal of the user.

Here, the purchase information may include a list of items bought by the user, price, etc., and a shopping list or a storage list stored in the user terminal may be changed according to the purchase information.

The user can transmit the purchase information to the server system using the terminal. The server system includes the database server as shown in FIG. 1, and the purchase/shopping history or shopping list corresponding to the user, stored in the database server, can be changed or updated.

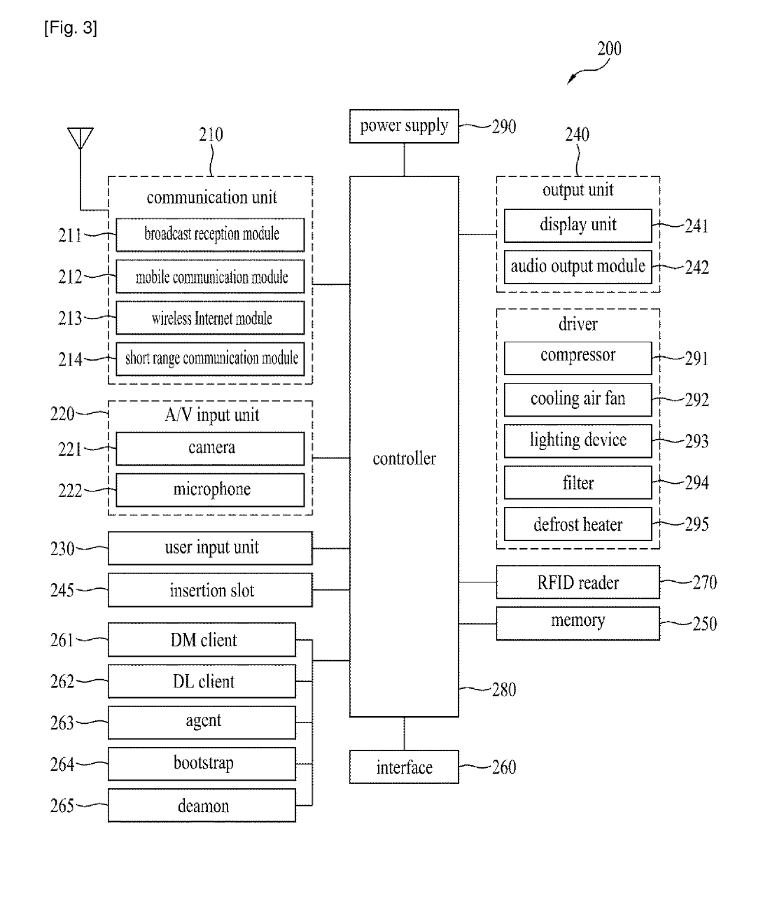

Referring to FIG. 3, a terminal 200 of home appliances according to the present invention may include a communication unit 210, an audio/video (A/V) input unit 220, a user input unit 230, an output unit 240, a memory 250, an interface 260, an RFID reader 270, a controller 280, a power supply 290, and an insertion slot 245.

These components will now be described in detail.

The communication unit 210 may include one or more modules that enable use of the Internet between the terminal 200 and a wired or wireless communication system or in a network in which the terminal 200 is located.

For example, the communication unit 210 may include a broadcast receiving module 211, a mobile communication module 212, an Internet module 213, a short range communication module 214, etc.

The broadcast receiving module 211 receives broadcast signals and/or broadcast related information from an external broadcast management server through a broadcast channel under the control of the controller 280 and reproduces the received broadcast signals and/or broadcast related information on a display unit 241.

The mobile communication module 212 transmits/receives signals to/from at least one of a base station, an external terminal and a server on a mobile communication network.

The signals may include an audio signal, a video phone signal, or various types of data according to transmission and reception of text/multimedia messages.

The Internet module 213 may correspond to a module for wired/wireless Internet access. Wireless Internet technologies may include WLAN (Wireless LAN) (Wi-Fi), WiBro (Wireless Broadband), WiMax (World interoperability for Microwave Access), HSDPA (High Speed Downlink Packet Access), etc.

The short range communication module 214 is a module for short range communication. Short range communication technologies may include Bluetooth, RFID (Radio Frequency Identification), IrDA (Infrared Data Association), UWB (Ultra Wideband), ZigBee, etc.

The A/V input unit 220 is used for audio signal or video signal input and may include a camera 221 and a microphone 222.

The camera 221 may process video data such as still images or moving pictures obtained by an image sensor in a video call mode or a photographing mode. The processed video data may be displayed on the display unit 241.

The video data processed by the camera 221 may be stored in the memory 250 or transmitted to an external device through the communication unit 210. The terminal may include two or more cameras according to the environment in which the terminal 200 is used.

The microphone 222 receives an external audio signal in a call mode, a recoding mode, or a speech recognition mode and processes the external audio signal into electric audio data.

The user input unit 230 may receive input data required for controlling operations of the terminal 200 from a user.

The user input unit 230 may include a keypad, a direction key, a dome switch, a touchpad (e.g., constant/voltage/capacitance), a jog wheel, a jog switch, etc.

The output unit 240 generates video or audio output and may include the display unit 241 and an audio output module 242.

Here, the audio output module 242 may be configured in the form of a speaker.

The display unit 241 displays (outputs) information processed in the terminal 200.

For example, when the terminal 200 displays information regarding a refrigerator, the information may be displayed as a user interface (UI) or graphical user interface (GUI) such as widgets, icons, etc.

The display unit 241 may include at least one of a liquid crystal display (LCD), a thin film transistor liquid crystal display (TFT LCD), an organic light-emitting diode (OLED), a flexible display, and a 3D display.

When the display unit 241 and a touch-sensing sensor (hereinafter referred to as ‘touch sensor’) form a layered structure (hereinafter referred to as ‘touchscreen’), the display unit 241 may be used as an input device in addition to an output device.

The touch sensor may be configured in the form of a touch film, a touch sheet, or a touchpad, for example.

The touch sensor may convert a variation in pressure, applied to a specific portion of the display unit 241, or a variation in capacitance, generated at a specific portion of the display unit 241, into an electric input signal. The touch sensor may sense pressure, position, and an area (or size) of the touch.

When the user applies a touch input to the touch sensor, a signal corresponding to the touch input may be transmitted to a touch controller (not shown). The touch controller may then process the signal and transmit data corresponding to the processed signal to the controller 280.

Accordingly, the controller 280 may detect a touched portion of the display unit 241.

The audio output module 242 may output audio data stored in the memory 250 or output an audio signal for signaling an operation state related to a refrigerator to the user.

The audio output module 242 may include a receiver, a speaker, a buzzer, etc.

The memory 250 may store programs for processing and control of the controller 280 and information related to operation of the refrigerator.

Furthermore, the memory 250 may receive and store real-time shopping information or item information according to the present invention.

The shopping information may be acquired from an external market management server through the communication unit 210.

In addition, the memory 250 stores graphic data for providing the shopping information and item information as various visual effects to the user.

The memory 250 may include at least one of a flash memory, a hard disk, a multimedia card micro type memory, a card type memory (e.g. SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk.

The interface unit 260 may serve as a path to external devices connected to the terminal 200.

The interface unit 260 may receive data or power from the external devices, transmit the data or power to internal components of the terminal 200, or transmit data of the terminal 200 to the external devices.

For example, the interface unit 170 may include a wired/wireless headset port, an external charger port, a wired/wireless data port, a memory card port, a port for connecting a device having a user identification module, an audio I/O port, a video I/O port, and/or an earphone port.

Preferably, the terminal 200 further includes components for managing information about operations of the home appliances and updating firmware in addition to the above-mentioned components.

The additional components may include a DM client 261, a DL client 262, an agent 263, a bootstrapper 264, and a daemon 265.

The DM client 261 executes a management command of the DM server. That is, the DL client 261 provides firmware update management, software management, diagnostic management, a management function for remotely processing a control management operation, etc. according to terminal management commands of the DL server.

FIG. 2 illustrates an example of a terminal including the DM client 261. In the case of a terminal including the display unit 241, the DM client may be mounted on a circuit board (display board) of the display unit 241.

A main board is a circuit board for executing functions of the terminal.

For example, in the case of a refrigerator, a main controller for controlling a defrost heater may be included in the main board.

While the DM client 261 may be mounted on the main board of the terminal, it may be advantageous to mount the DL client 261 on the display board because a display window may be frequently used to request a management service.

The DL client 262 downloads package files (a firmware update package, a software management package, etc.) from the DL server. The DL client 262 is provided with a download server URL from the DM client, accesses a download server using the download server URL, receives a download descriptor (DD) and performs a download operation.

The agent 263 executes a management service command requested by the terminal according to management service type.

For example, an update agent generates new firmware using an update package that has been downloaded for firmware update. The update agent may be implemented by a manufacturer in various manners.

The daemon 265 may process periodic access of the terminal to the server system or a market management server.

The daemon 265 may remain on as long as the terminal 200 is powered on.

The controller 280 may control overall operations of the terminal 200. In this case, the controller 280 may be a microprocessor included in the refrigerator.

The power supply 290 may receive power of the refrigerator or external power provided through the interface unit 260 and provide power required for operating the components of the terminal 200 under the control of the controller 280.

Embodiments of the present invention may be implemented in a recording medium readable by a computer or similar devices using software, hardware or a combination thereof.

According to a hardware implementation, embodiments of the present invention may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and/or electrical units for executing functions.

In some cases, the embodiments of the present invention may be implemented using the controller 280.

According to a software implementation, embodiments including procedures or functions may be implemented using a separate software module executing at least one function or operation described in the specification.

Software codes may be implemented according to a software application written in an appropriate software language. The software codes may be stored in the memory 250 and executed by the controller 280.

The controller 280 may be connected with a driver that drives a compressor 292, a cooling air fan 293, a lighting device 296, a filter 295, and a defrost heater 297.

Accordingly, these components may be operated according to commands from the controller 280.

A description will be given of a communication environment including the terminal, the server system and a market management server.

Any communication environment is applicable so long as the above-mentioned management services can be provided thereby.

FIG. 1 illustrates an exemplary communication environment in which a wireless Internet communication module is applied to the terminal such that the terminal communicates with the server system using the Internet through AP.

Considering a communication path from the terminal to the server system, a portion of the communication path after the AP corresponds to public Internet and a portion of thereof before the AP corresponds to private Internet. The terminal receives a private IP address from the AP, and the AP has its own IP address.

The server system and the market management server are linked with the Internet through a web server. A fire wall is installed in the server system and the market management server.

The server system and the market management server have IP addresses. The IP addresses of the server system and the market management server may be unique IP addresses thereof.

The web server protects not only the server system and the market management server but also other systems. The web server may be an initial access point connected to the terminal for security.

For security, a DNS server may be used.

When the terminal attempts to access the server system using a URL address, the DNS server converts the URL into the IP address of the server system such that the terminal can be linked with the server system and the market management server. In this case, the terminal is linked with the server system and the market management server using URL addresses of the server system and the market management system.

The DM client continuously sends a signal to the DM server such that the server system and the market management server detect the location of the terminal to find the terminal.

The AP transmits IP information thereof and information on a port to which the terminal is connected to the DM server, and the DM server recognizes the location of the DL client.

When the terminal transmits account information to the server system and the market management server, the server system and the market management server can recognize the location of the terminal and access the terminal using the information.

In order for the terminal to access the server system and the market management server, the IP address or URL address of the server system may be input to the terminal.

When the terminal is present on a private network, the terminal may not have a unique IP, and thus the server system and the market management server cannot access the terminal using the IP address of the terminal.

Accordingly, it may be necessary to set the terminal such that the terminal periodically transmits a signal to the server system.

A description will be given of a user interface implemented on the display unit 241 of the refrigerator having the aforementioned configuration.

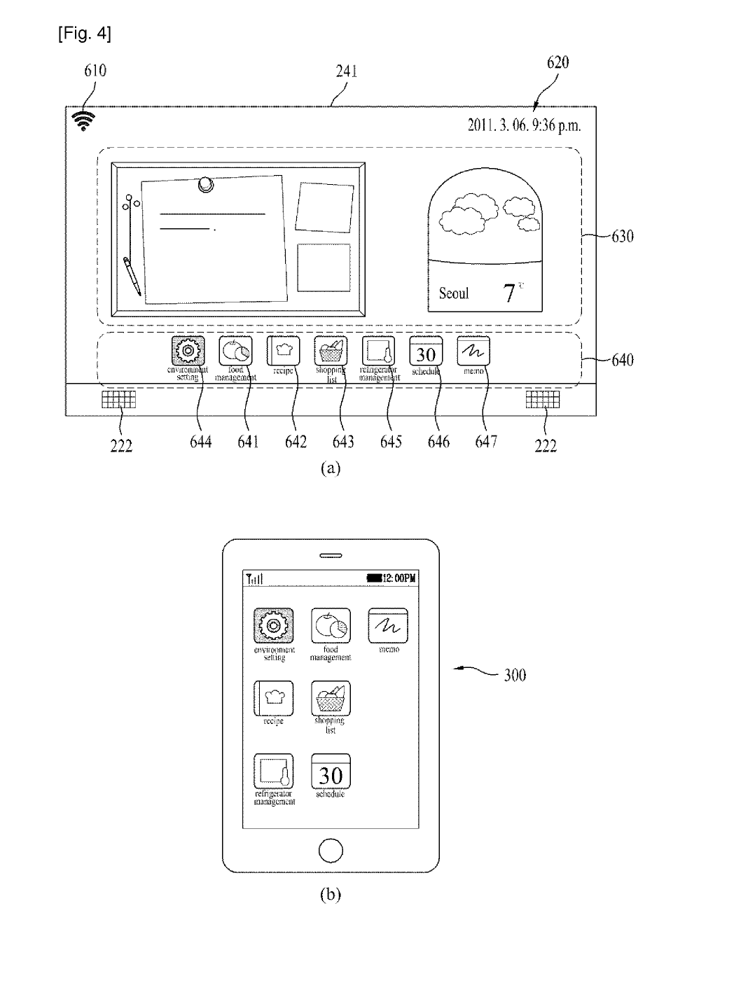

FIG. 4 shows an exemplary initial screen displayed on the display unit of the terminal according to an embodiment of the present invention.

It is assumed that the display unit is a touchscreen in the following figures including FIG. 4.

The initial screen may be initially displayed when the refrigerator is powered on and an operating system (OS) has been booted, or may be displayed when an event of turning off the display unit and then turning on the display unit again (e.g. a user input unit is operated or a storage chamber door is opened) is generated.

Referring to FIG. 4(a), an indicator 610 indicating Wi-Fi reception intensity may be displayed at the top of the left end of the display unit 241 and the current time 620 may be displayed at the top of the right side of the display unit 241.

The indicator 610 may changes according to a currently activated wireless interface. Various widgets are displayed in the middle of the display unit and menu icons executable through the touchscreen are arranged at the bottom of the display unit.

More specifically, the icons may include a food management icon 641, a recipe icon 642, a shopping list icon 643, an environment setting icon 644, a refrigerator management icon 645, a schedule icon 646 and a memo icon 647, which are displayed at the bottom of the display unit.

In addition, microphones 222 and 222′ for converting a voice command of a user into an electric signal may be displayed at the bottom of the display unit 241.

Arrangements/locations/types of the menu icons, indicator and widgets illustrated in FIG. 4 are exemplary, and the present invention is not limited and may be applied to various configurations.

FIG. 4(b) shows that the screen displayed on the terminal of the refrigerator is displayed on a mobile terminal 300 such as a smartphone.

Since the screen and function implemented in the mobile terminal 300 are identical to those of the terminal of the refrigerator, description of the screen displayed on the mobile terminal is omitted.

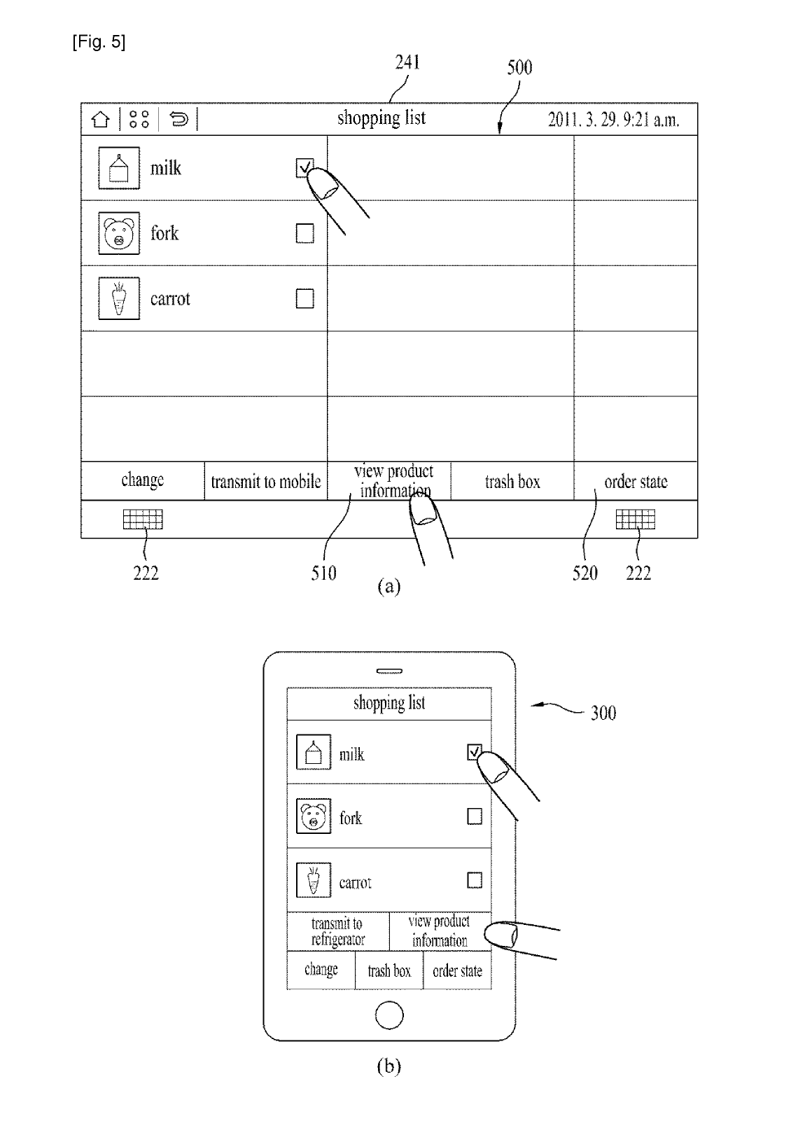

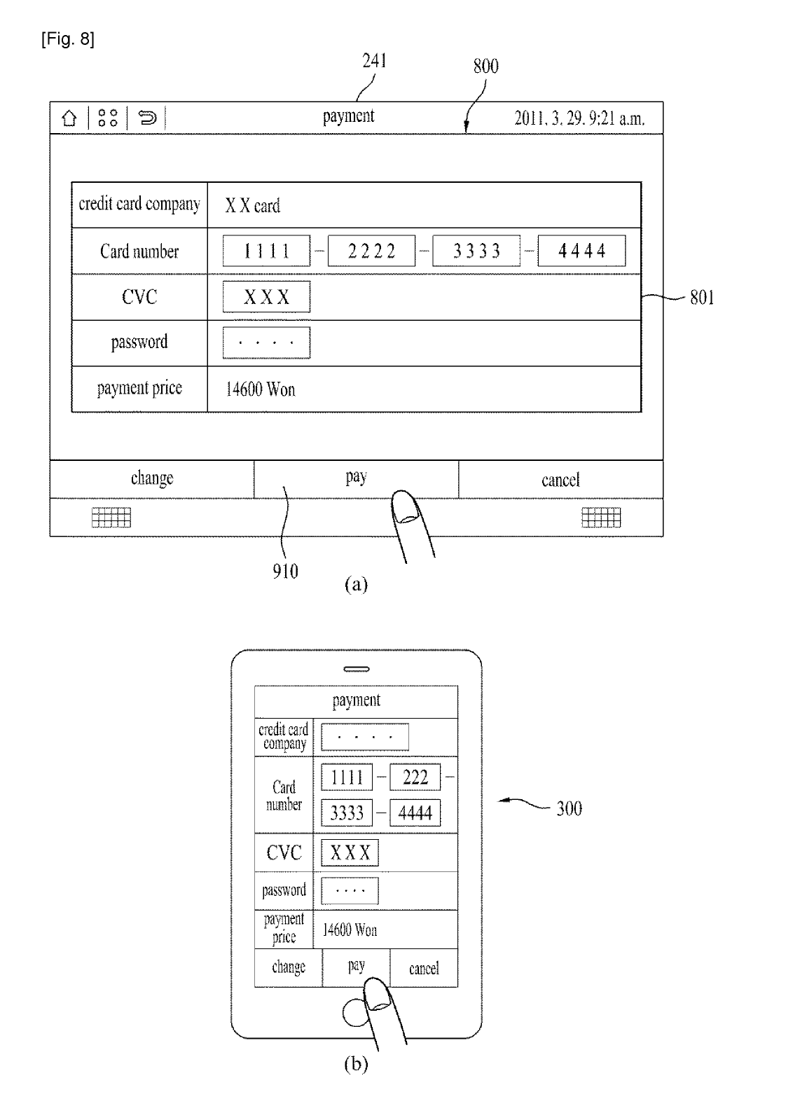

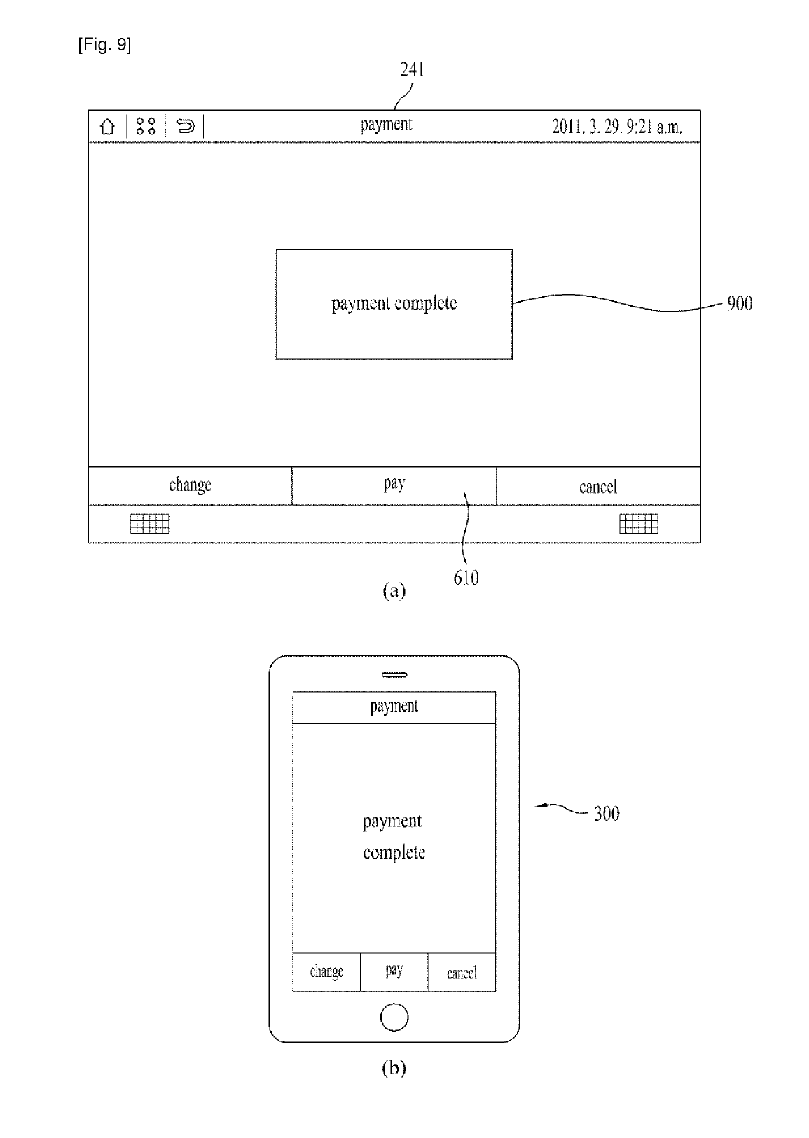

In the following, descriptions of FIGS. 5(b) to 12(b) correspond to descriptions of FIGS. 5(a) to 12(a), and thus the descriptions of FIGS. 5(a) to 12(a) will substitute for the descriptions of FIGS. 5(b) to 12(b).

The user may touch the shopping list icon 643 on the initial screen, as shown in FIGS. 4(a) and 4(b).

When the shopping list icon 643 is touched, the screen is changed to display a shopping list 500 generated by the user, as shown in FIG. 5(a).

The user may generate the shopping list 500 for purchasing necessary items by directly inputting the names of the items or selecting specific items from lists arranged by items.

When the shopping list 500 includes a plurality of items and the user wants to check price information and details of each item, the user selects a specific item and inputs an item information view command by touching an item information view button 510 displayed at the bottom of the shopping list 500.

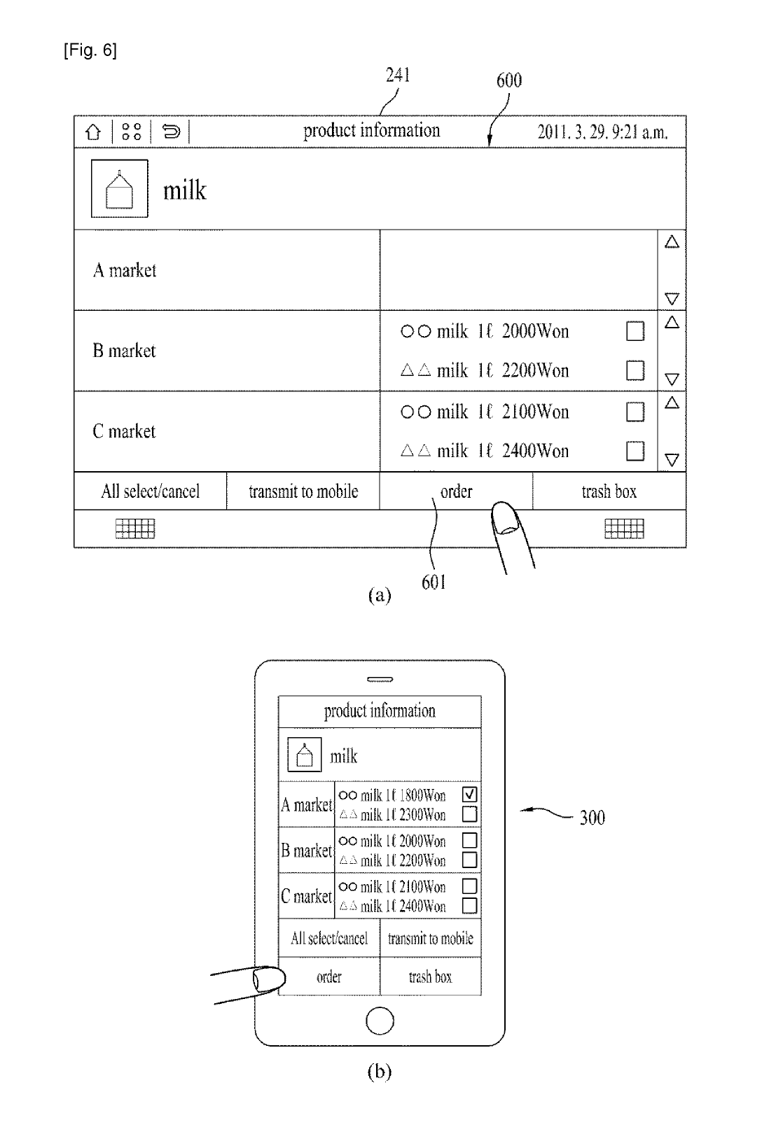

In this case, details 600 of specific item information are displayed on the display unit 241, as shown in FIGS. 6(a) and 6(b).

Here, the details 600 of item information may be configured of a price information list for each market.

When a plurality of markets is present, the names of the plurality of markets and items sold by each market are displayed.

In the present embodiment, when the user requests detailed information about milk, three markets and 2 types of milks sold by each market are displayed.

The displayed markets may be markets located adjacent to the user or markets designated by the user.

In this state, when the user selects a specific item of a specific market and touches an order button, a list 700 of items ordered by the user is displayed on the display unit 241.

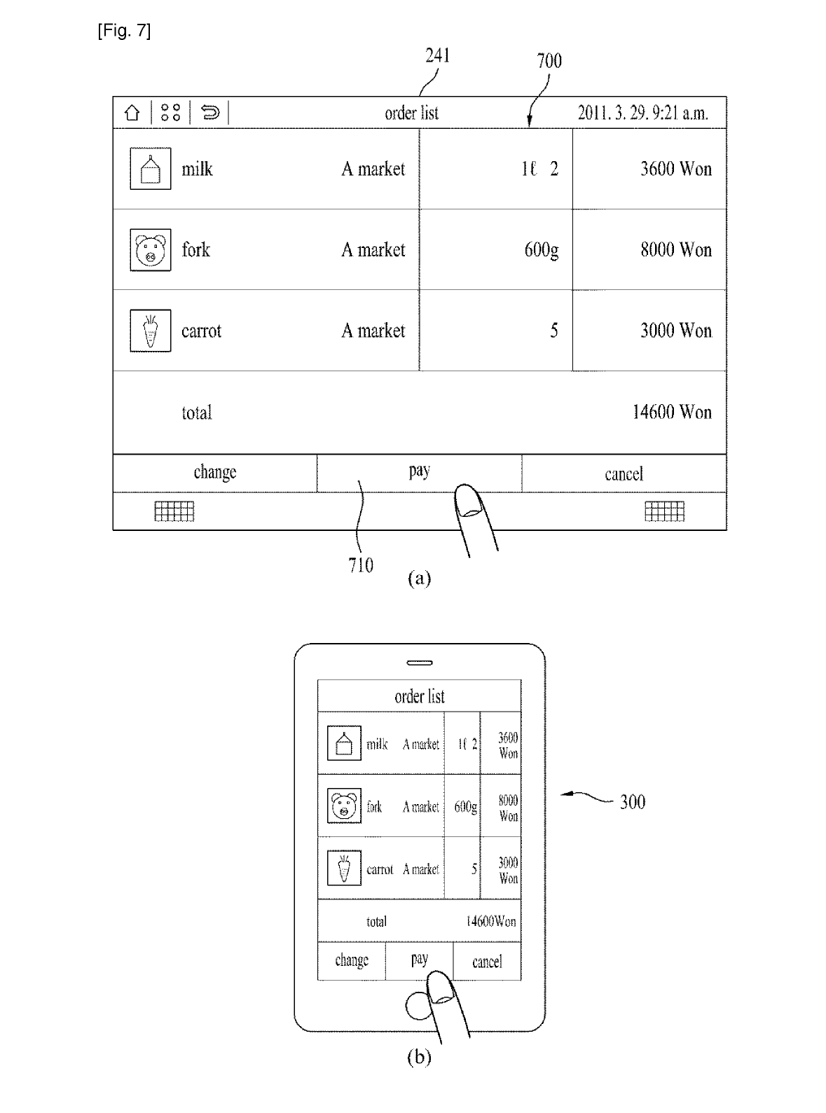

FIGS. 7(a) and 7(b) shows a case in which all items on the shopping list have been ordered.

When the user orders items, markets selling the ordered items, types of the items, the number of each item, prices of the items and the total amount are displayed in an arranged form.

When the user touches a payment button 710 displayed at the bottom of the item order list 700, the screen changes to display a payment screen 800.

The payment screen 800 displays a payment window 801 activated by a payment program provided by a payment proxy service.

When the payment proxy service provider is a credit card company, the user can perform payment by inputting a credit card number, a CVC number of the credit card, and a password to the payment window 801. If the payment proxy service provider is a bank, the user can complete payment by transferring payment to a virtual account provided by the bank to the corresponding market.

In this state, when the user touches a payment execution button 810, the screen changes to display a payment completion pop-up window 900 to inform the user that the items have been purchased.

If the user wants to know a current order state or delivery state after purchase, the user touches an order state button 520 shown in FIGS. 5(a) and 5(b).

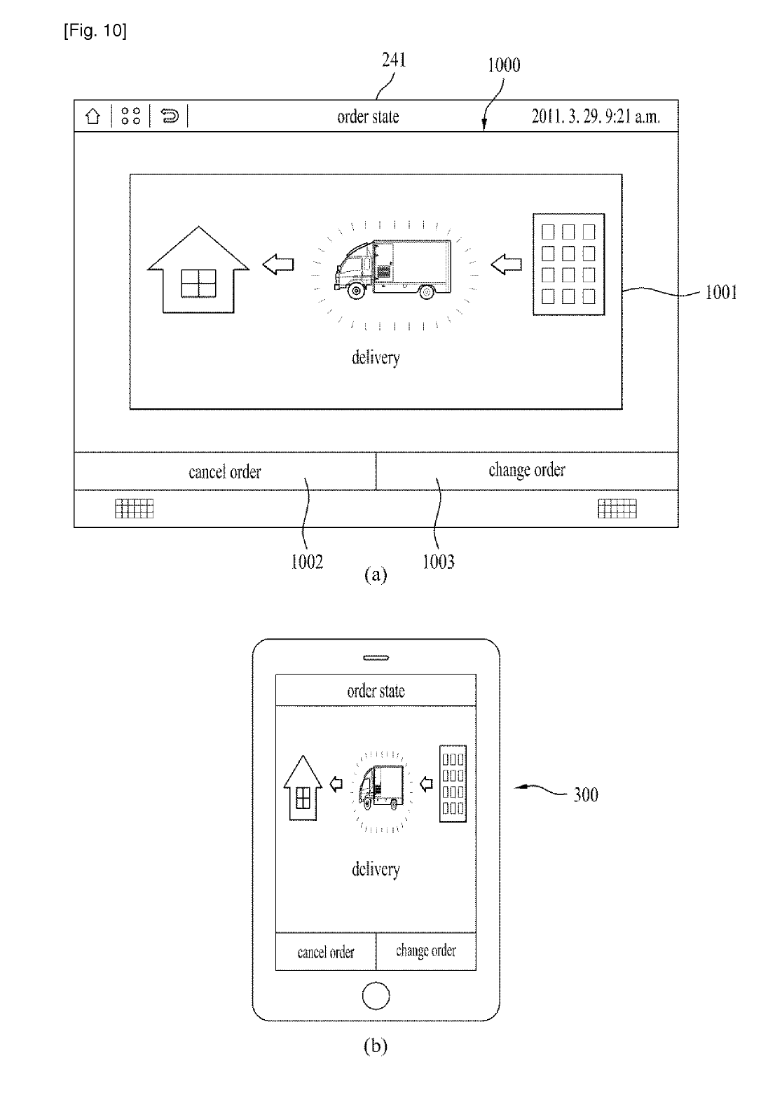

Then, an order state screen 1000 is displayed on the display unit 241 and a pop-up window 1001 indicating a current delivery state or an order processing state is displayed on the order state screen 1000, as shown in FIGS. 10(a) and 10(b).

In addition, an order cancel button 1002 and an order change button 1003 are displayed below the pop-up window 1001. The user can cancel or change an order by touching the order cancel button 1002 or the order change button 1003.

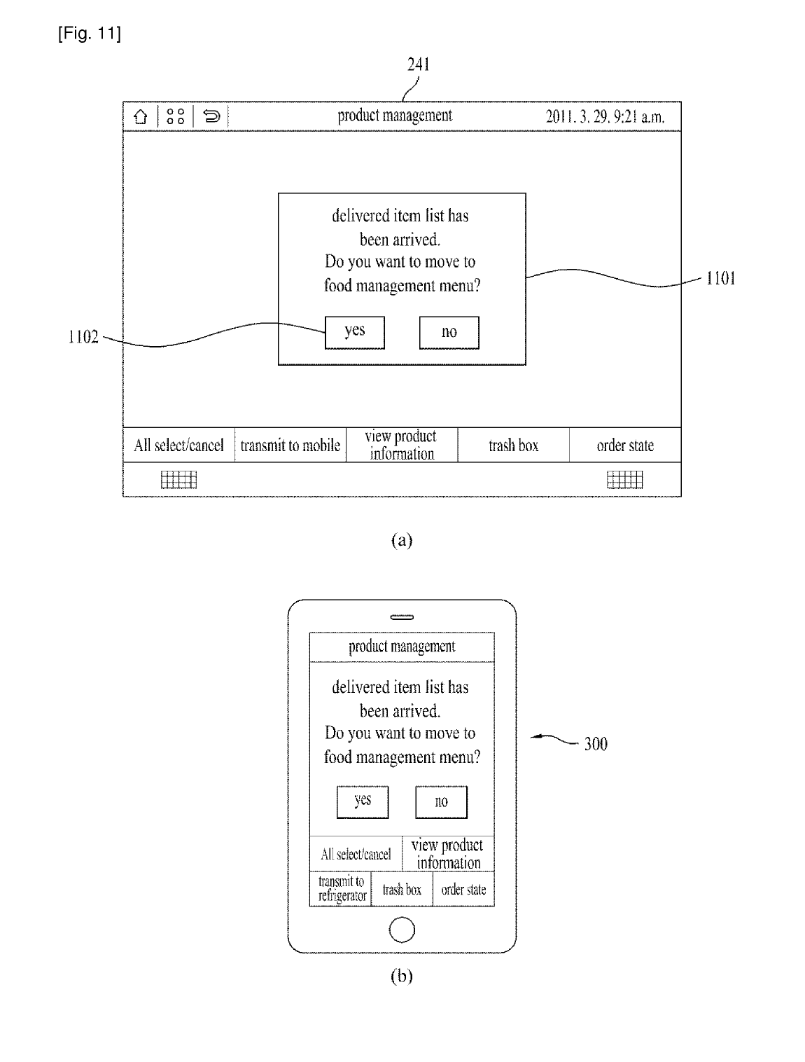

Referring to FIGS. 11(a) and 11(b), upon completion of delivery of ordered items, a list of the delivered items is received from a management server of the corresponding market, and a pop-up window 1101 inquiring about food (or stored goods) management using the list is displayed.

The user may want to store items on the list of the delivered items in a storage and it may be necessary to generate management information about the stored food or stored goods by linking the list to a food management menu.

Upon recognition of this necessity, the user can touch a ‘yes’ button displayed on the pop-up window 1101 to change the screen to a food management menu screen 1200.

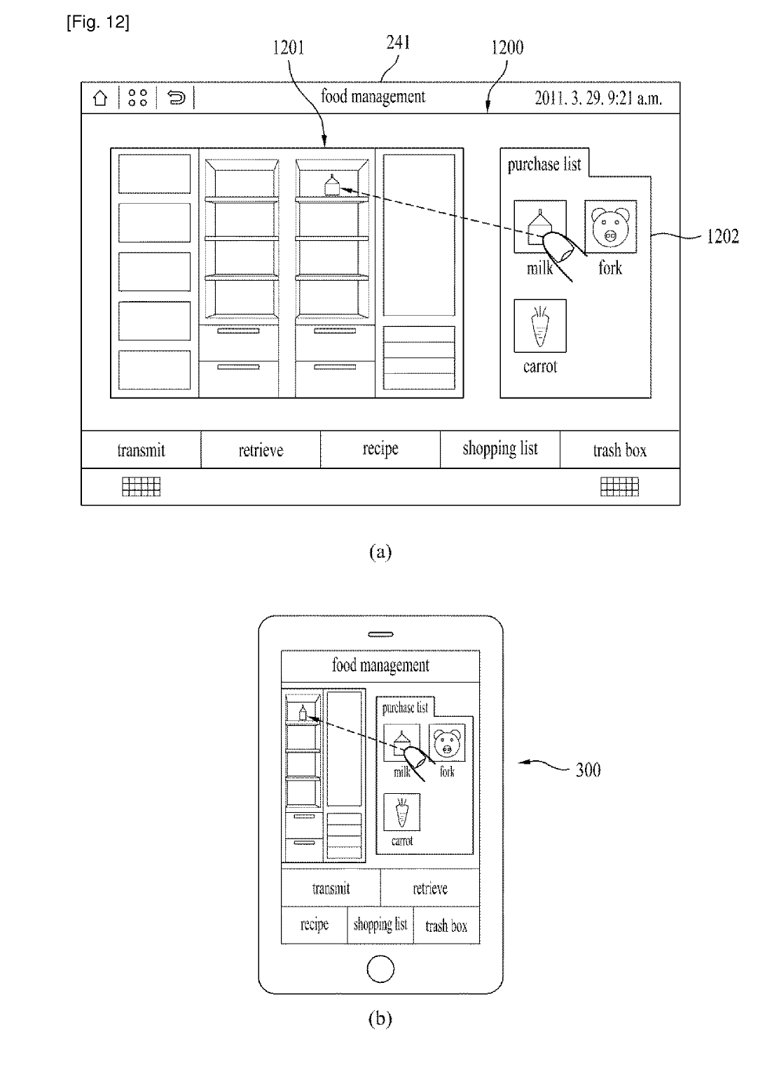

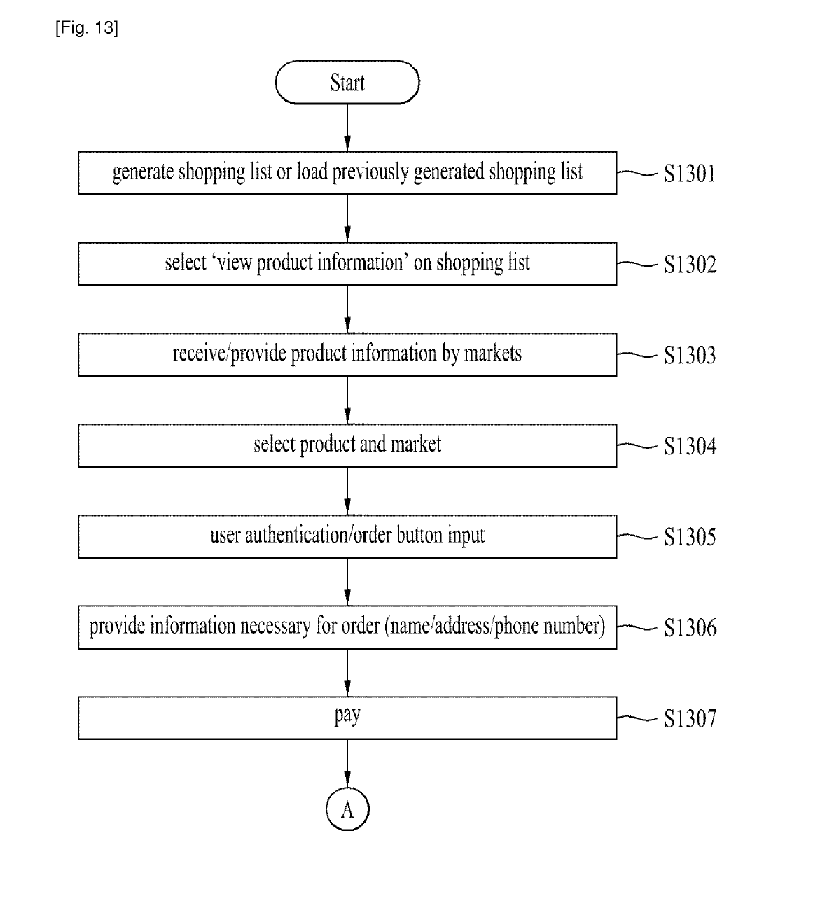

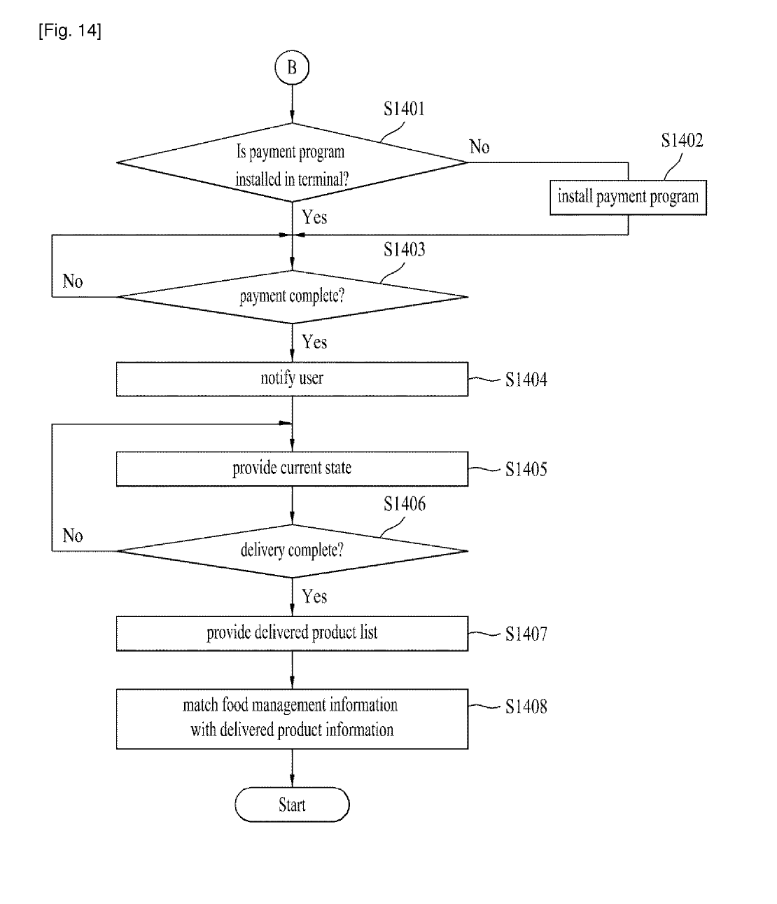

Referring to FIGS. 12(a) and 12(b), a virtual storage 1201 is displayed at one side of the food management menu screen 1200 and a purchase list 1202 is displayed at one side of the virtual storage 1201.

When the user touches an icon corresponding to an item displayed on the purchase list 1201, drags and drops the touched icon onto the virtual storage 1201, the icon is located in the virtual storage 1201.

By arranging purchased items in the virtual storage 1201 through the food management menu screen 1200 in this manner, the user can be easily aware of items stored in the storage without directly opening the actual storage.

A description will be given of an item shopping flow based on the shopping list.

First of all, the user generates a shopping list or loads a previously generated shopping list (S1301) and selects ‘view information’ about an item on the shopping list' (S1302).

In this case, the terminal of the user receives details of item information for each market from management servers connected to designated markets and displays the received details of item information such that the user can view them (S1303).

The user selects a market and an item (S1304) and touches an order button after user authentication (S1305). Then, a pop-up window requesting that the user input information necessary to order the item is displayed on the display unit. The user inputs the information (a name, an address and a phone number) necessary for order to the pop-up window (S1306).

When the user touches the payment execution button upon inputting the necessary information (S1307), it is determined whether a payment program is installed in the terminal (S1401).

When a payment program is not installed in the terminal, a server operated by the payment proxy service provider is accessed to download the payment program and install the downloaded payment program in the terminal (S1402).

Upon installation of the payment program, payment is performed. Here, a credit card number, a password, etc. are input when the payment proxy service provider is a credit card company whereas a payment price is transferred into a virtual payment account when the payment proxy service provider is a bank.

Subsequently, it is determined whether payment has been finished (S1403). When payment has been finished, a predetermined message is transmitted to the user such that the user checks details of purchase through the message (S1404). The message may be configured in the form of a short message such as an SMS message.

Since the market management servers can signal a current processing state after purchase to the terminal, the user can check an order state and a delivery state through the terminal if the user wants to confirm purchase.

Upon completion of delivery (S1406), a list of items delivered from the corresponding market is provided to the terminal (S1407).

Then, the user matches food management information with information on delivered items on the food (stored goods) management menu using the list of delivered items.

In this case, the user can store the delivered items in the actual storage, display the list of the delivered items on the food management menu and move icons corresponding to the delivered items on the list to the virtual storage (S1408).

Accordingly, the user can check storage states of food and other stored items without opening the actual storage.

1. An information management system comprising:
a terminal including a memory for storing storage information about items stored in a storage of home appliances capable of storing predetermined items and information about a shopping list, an input/output unit for inputting/outputting the storage information and the information about the shopping list, a communication unit connected to a management server of an external market through a predetermined communication network to enable shopping based on the shopping list, and a controller for controlling the input/output unit, the memory and the communication unit; and
a server configured to be connected to the terminal through the communication network, to store and manage shopping information and the shopping list information input through the terminal, and to change contents of the stored information according to a shopping result at the market.

2. The information management system according to claim 1, wherein the server includes a database server related to shopping information,
wherein databases constructing the database server comprise:
a user information database in which personal information for identifying a user is stored;
a shopping list information database in which the shopping list information is stored;
a purchase history information database in which shopping history information of the user is stored; and
a product information database in which information about details of items on the shopping list or the shopping history is stored.

3. The information management system according to claim 2, wherein the server includes a device management server for managing information about operations of home appliances communicating with the terminal.

4. The information management system according to claim 2, wherein the input/output unit is configured of a display unit implemented as a touchscreen,
wherein the display unit displays a virtual storage of home appliances and information about stored items or an icon corresponding to an item related to the shopping information,
wherein the icon is located outside or inside of the virtual storage according to drag and drop operations.

5. The information management system according to claim 4, wherein the controller displays the shopping list input by the user on the display unit when the user presses a shopping list button.

6. The information management system according to claim 5, wherein, when the user selects a specific item included in the shopping list and inputs a command for viewing information about the specific item, the controller receives information about the specific item, provided by external market management servers, and displays the received information on the display unit.

7. The information management system according to claim 6, wherein the information about the specific item includes price information provided by a plurality of external markets.

8. The information management system according to claim 7, wherein markets connected to management servers providing the information about the specific item are located within a predetermined distance from the location of the home appliances or designated by the user.

9. The information management system according to claim 5, wherein, when the user selects a specific item of a specific market, inputs an order command and then inputs a payment command, the controller displays a payment information input window provided by a predetermined payment service provider on the display unit.

10. The information management system according to claim 9, wherein, when the user inputs an order or delivery check command, the controller receives delivery related information from a management server of the specific market and displays order information or delivery information on the display unit.

11. The information management system according to claim 10, wherein, when a list of delivered items is received from the management server of the specific market, the controller displays a list of purchased items and a virtual storage on the display unit,
wherein the list of purchased items includes icons representing the items and the items are located in the virtual storage according to drag and drop operations.

12. A refrigerator comprising:
a storeroom capable of storing predetermined items; and
a terminal provided to a door for opening and closing the storeroom, the terminal to store, input and output storage information about food or items stored in the storeroom and a shopping list, and to be connected to a management server of an external market through a communication network to input/output predetermined shopping related information to enable shopping of food or stored items,
wherein the terminal displays information about the shopping list, information about items included in the shopping list, received from the management server of the external market, information about purchased items according to a shopping result at the market and storage information related to the information about purchased items.
